(19) United States
(12) Patent Application Publication
(10) Pub. No.: US 2010/0332130 A1
(43) Pub. Date: Dec. 30, 2010

(54) VEHICLE NAVIGATION APPARATUS

(75) Inventors: Yasuhiro Shimizu, Tokoname-city (JP); Hiroaki Sekiyama, Tokyo (JP); Kazutaka Yoshikawa, Okazaki-city (JP); Tomofumi Shibata, Okazaki-city (JP); Takamitsu Sakai, Okazaki-city (JP); Nobuhiro Mizuno, Ichihara-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, KARIYA-CITY, AICHI-PREF (JP); DENSO CORPORATION, KARIYA-CITY, AICHI-PREF (JP); TOYOTA JIDOSHA KABUSHIKI KAISHA, TOYOTA-CITY, AICHI-PREF (JP); AISIN AW CO., LTD., ANJO-CITY, AICHI-PREF (JP)

(21) Appl. No.: 12/735,562

(22) PCT Filed: Jun. 26, 2009
(86) PCT No.: PCT/JP2009/062177

§ 371 Date: Jul. 27, 2010

(30) Foreign Application Priority Data
Jun. 30, 2008 (JP) 2008-170439

(51) Int. Cl. G01C 21/26

(52) U.S. Cl. 701/209

(57) ABSTRACT

A vehicle navigation apparatus determines whether or not the currently traveled route having a current vehicle position matches with estimated routes after determining, on the basis of the traveled route history, the estimated routes which correspond to destination candidates. Then, the navigation apparatus further determines whether or not the subsequent portion of the estimated route overlaps with other estimated route, for selecting one of the destination candidates. The vehicle navigation apparatus thus selects the destination candidate, in a highly accurate manner in terms of user preference, based on the traveled route history.

### CROSS-REFERENCE TO RELATED APPLICATION

The present application is based on and claims the benefit of priority of Japanese Patent Application No. 2008-170439, filed on Jun. 30, 2008, the disclosure of which is incorporated herein by reference.

### TECHNICAL FIELD

The present disclosure generally relates to a vehicle navigation apparatus having a map-matching function and a history recording function.

### BACKGROUND ART

The vehicle navigation apparatus, when operated by an occupant of the vehicle through operation interface such as an operation switch, a remote controller or the like, sets a destination in the apparatus, searches for a route to reach the destination, and warns a driver/occupant of the vehicle that a traffic congestion is expected on the searched route together with a display of an alternative route that avoids the traffic congestion. The driver of the vehicle, however, does not always operate the operation interface of the navigation system for setting the destination, because it may be bothering for the driver/occupant to explicitly setting a frequented destination of daily travel. In this case, as a trade-off for saving the destination setting, the driver cannot receive the above-described congestion warning and/or alternative route guidance.

Japanese patent documents JP-A-H07-83678 and JP-A-2007-10572 (i.e., US 20070005235) disclose, for example, a technique such as a destination selection based on a travel history and destination reach rate, or a destination selection based on an estimation of travel purposes. That is, in one case, a selection of multiple destination candidates is performed based on a traveled route history that includes previously traveled routes, accompanied by a determination of the destination based on a current vehicle position and a destination reach rate from that vehicle position. Further, in another case, the travel purpose is estimated first for narrowing the scope of the destination candidates.

However, if the destination candidate is determined, as described in the above disclosure, based on the current vehicle position and the destination reach rate from that position, the destination candidate that is less frequented cannot be selected and determined as user-desired destination, thereby giving the user an impression of less probable and enabling operation scheme. Further, the estimation of travel purpose requires a complicated process, thereby making it difficult for the apparatus to implement it.

### DISCLOSURE OF INVENTION

In view of the above and other problems, the present disclosure provides a vehicle navigation apparatus that achieves an improved usability by estimating in an accurate manner a desired destination of a travel without employing a complicated process when a driver/occupant of the vehicle does not set the destination of the travel through user interface.

According to an aspect of the disclosure, the vehicle navigation apparatus includes: a current position detection unit, a road data acquisition unit, a map matching unit, a travel history store unit. The map matching unit matches a current vehicle position detected by the current position detection unit with the road data acquired by the road data acquisition unit, and the travel history store unit stores traveled routes traveled by a vehicle as travel history of the vehicle. The navigation apparatus further includes: a destination history store unit for storing one of (a) the current vehicle position being detected by the current position detection unit at a time immediately before system power off and (b) a destination having been input by an occupant of the vehicle though an operation of an operation unit, as destination history; a destination candidate estimation unit for estimating a destination candidate based on the destination history stored in the destination history store unit; a route estimation unit for generating a route estimation that corresponds to the estimated destination candidate based on the travel history stored in the travel history store unit; a route determination unit for determining whether the current vehicle position exists on the route estimation based on a comparison of the current vehicle position detected by the current position detection unit with the route estimation generated by the route estimation unit; and a destination selection unit for selecting the destination candidate based on a determination whether a portion of one route estimation extending from the current vehicle position to the destination candidate is at least partially shared with another route estimation, when the current vehicle position is determined to be existing on the route estimation by the route determination unit.

By devising the above-described operation scheme, the traveled route history is used to determine the estimated routes corresponding to the destination candidates in the vehicle navigation system, instead of using the travel frequency to the destination, and the currently traveled route having the current vehicle position located thereon is examined in terms of matching with the estimated route. Further, when the currently traveled route is matching with the estimated route, overlapping of a subsequent section of the estimated route, which is extending from the current vehicle position to the destination candidate, with other estimated routes is examined, for the purpose of narrowing the scope of the destination candidates, thereby enabling a determination of a user-desired destination in an accurate manner without employing a complicated estimation process for estimating the travel purpose in association with currently traveled route. That is, the navigation apparatus attains an improved usability without, for example, increasing a production cost.

Objects, features, and advantages of the present disclosure will become more apparent from the following detailed description made with reference to the accompanying drawings, in which:

### BRIEF DESCRIPTION OF DRAWINGS

FIG. 1 is a block diagram showing a configuration of a vehicle navigation apparatus in an embodiment of the present disclosure.

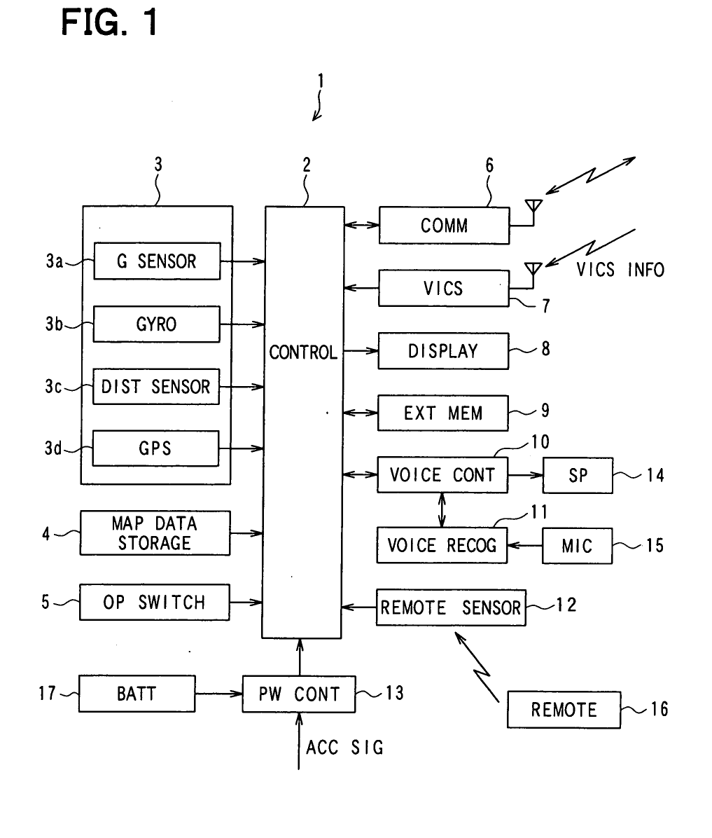

FIG. 2 is a flowchart of a process performed in the navigation apparatus;.

FIGS. 3A and 3B are illustrations of a current vehicle position on estimated routes.

FIGS. 4A and 4B are other illustrations of the current vehicle position on estimated routes.

FIGS. 5A and 5B are yet other illustrations of the current vehicle position on estimated routes.

### BEST MODE FOR CARRYING OUT THE INVENTION

An embodiment of the present disclosure is described in the following. As for a vehicle navigation system 1, following components are included. That is, a control unit 2 (corresponding to a current position detection unit, a road data acquisition unit, a map matching unit, a destination candidate estimation unit, a route estimation unit, a route determination unit, a destination selection unit, and a process unit in claim language), a position detector 3, a map data storage unit 4, an operation switch group 5 (corresponding to an operation unit in claim language), a communication unit 6, a VICS (registered trade mark) receiver 7 (“VICS” represents a traffic information system implemented in Japan), a display unit 8, an external memory 9 (corresponding to a travel history store unit and a destination history store unit in claim language), a voice controller 10, a voice recognition unit 11, a remote control sensor 12 and a power control unit 13.

The control unit 2 is formed mainly by using a micro-computer having a CPU, a ROM, a RAM, an I/O interface, a bus for connecting these parts together with other parts (not illustrated). The control unit 2 controls all of the operations of the vehicle navigation system 1. The position detector 3 is formed from a G sensor 3a, a gyroscope 3b, a distance sensor 3c and a GPS receiver 3d, each of these detector components having detection errors of respectively different natures. Therefore, the control unit 2 uses input signals from these components in a mutually compensating manner for improved detection accuracy. That is, a current vehicle position as well as a travel direction, a vehicle speed, a travel distance and the like are determined by using the detection signal from the position detector 3, by utilizing all those signals or by selecting required signals, depending on the desired accuracy. Further, the components in the position detector 3 may be selectively installed, and a steering sensor for detecting a steering wheel rotation and a tire sensor for detecting a tire rotation may also be additionally used.

The map data storage unit 4 stores digital map data which includes the road data, the background data, the text data and the facility data which, for example, are transferred from the storage medium such as a hard disk drive (HDD) a DVD-ROM, a memory card and the like. The control unit 2 matches the current vehicle position with the road data acquired from the map data storage unit 4 based on the detection signal input from each component of the position, detector 3. The operation switch group 5 is a group of switches such as mechanical switches arranged on the display unit 8 and a touch switch formed integrally on a color liquid crystal display. The occupant of the vehicle can instruct, by using the operation switch group 5, map scale change, menu display selection, destination setting, route search, start of the route guide, current position correction, screen change and volume adjustment, for example.

The communication unit 6 has a telephone function, and establishes mobile communication with an external communication device through communication channel. The VICS receiver 7 receives the VICS information (traffic information, weather information, date information, day of the week information, information of facility and advertise information, for example) which is transmitted from a VICS information center. The display unit 8 is formed, for example, from a color liquid crystal display, and displays menu screen which allows the occupant of the vehicle to choose from a list of menus as well as other screen such as a current position display screen that superposes a current position mark on a map or the like. The display unit 8 may be implemented by using an organic EL, a plasma display or the like.

The external memory 9 is formed, for example, as a flash memory card or the like that are removable. The external memory 9 stores routes traveled by the vehicle as travel history, and stores the current position of the vehicle immediately before the turning off of the system power as well as travel destinations input by the operation of the operation switch group 5 from the occupant.

The voice controller 10 controls voice output that is output from a speaker 14, as well as voice input from a microphone 15, for example. That is, when the control unit 2 executes the route guide, the voice controller 10 outputs voice guidance for the route guide from the speaker 14. The voice recognition unit 11 analyzes the voice input from the microphone 15 on the basis of speech recognition algorithm. The remote control sensor 12 receives radio signals from a remote controller 16 (corresponding to an operation unit in claim language) having multiple operation switches, and outputs the signal to the control unit 2. The remote controller 16 has multiple operation switches, and enables the occupant to perform the same instructions as the operation switch group 5. That is, the remote controller 16 allows the occupant to instruct map scale change, menu display selection, destination setting, route search, start of the route guide, current position correction, screen change, volume adjustment, and the like.

The power control unit 13 inputs an accessory (ACC) signal from an ACC switch, and controls the electric power supply to each functional block from a battery 17 on the basis of on and off of the ACC switch. When the ACC switch is turned on, the operational power is supplied for each of the function blocks thereby turning on the operation of the vehicle navigation system 1. When the ACC switch, is turned off, the operation of the vehicle navigation system 1 is turned on together with other function blocks. The control unit 2 detects on and off of the ACC switch by using the power control unit 13.

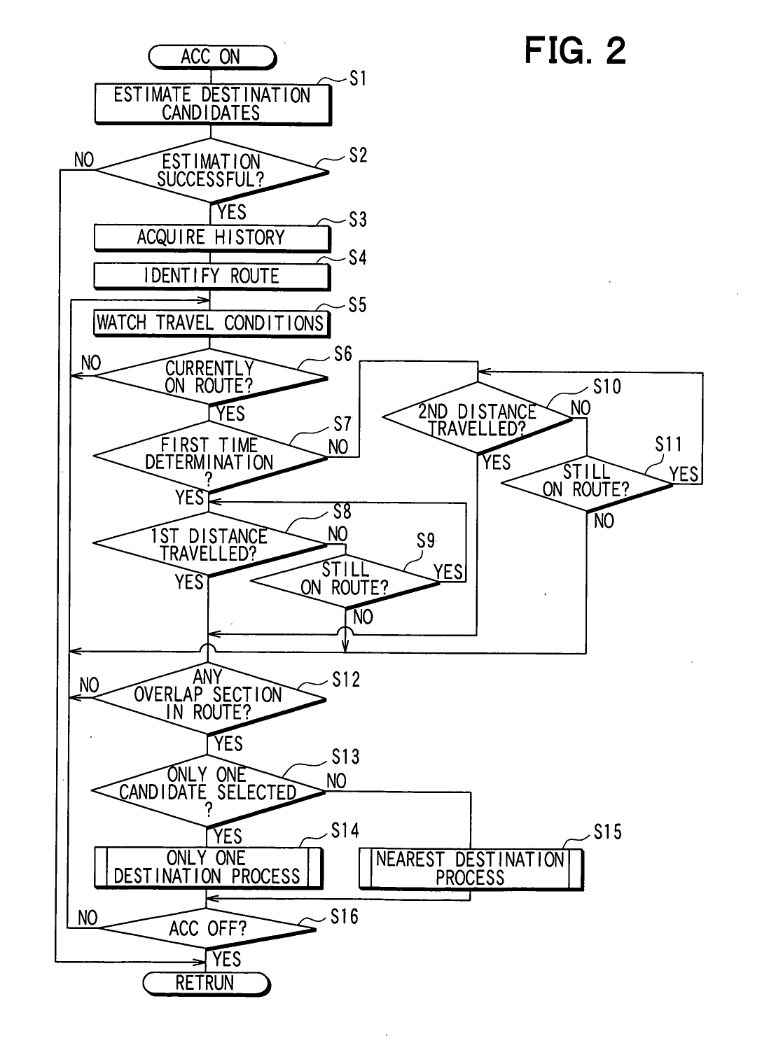

FIGS. 2 to 5 are used for describing a process concerning the operation of the above-described configuration.

The control unit 2. estimates a destination candidate by searching destination history in the external memory 9 when the ACC switch is turned on, based on a detection of the turning-on by the power control unit 13 (step S1). In this case, for example, the control unit 2 estimates the candidate by extracting a destination from among multiple destinations based on the number of settings by the operation of the switch 5, the remote controller 16, or based on the number of visit times of the vehicle to a destination. That is, the frequently-visited places are extracted as the estimated destinations.

Next, the control unit 2 determines whether the estimation is successful or not (step S2). If the destination estimation is successful (S2:YES), the process acquires the traveled route history from the external memory 9 (step S3). Then, by referring to the traveled route history acquired from the external memory 9, the process identifies the estimated route (i.e., route estimation) which corresponds to the destination candidate (step S4).

Then, the control unit 2 watches travel conditions of the vehicle by watching the current vehicle position (step S5), and determines whether the vehicle position currently exists on (or has reached) the estimated route (step S6). If it is determined that the current vehicle position is on the estimated route (S6:YES), the process then determines whether the “on-route determination” is for the first time (step S7).

If the “on-route determination” is for the first time (S7:YES), that is, if the current vehicle position is determined as “existing on the estimated route” for the first time after the start of the travel of the vehicle, then, the process determines whether the travel distance of the vehicle reaches a first distance (step S8), and further determines whether the current vehicle position is still existing on the estimated route (step S9).

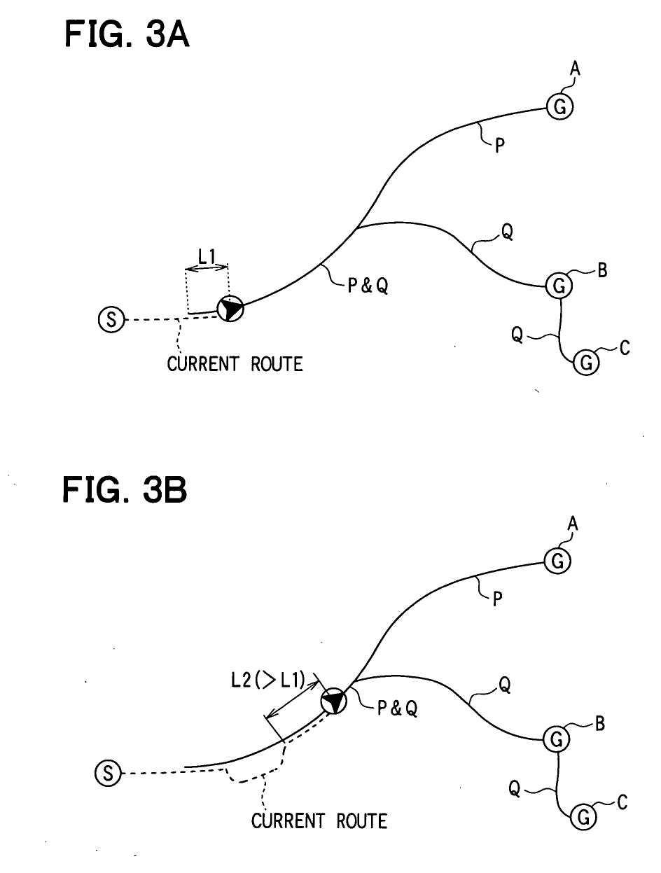

Then, the control unit 2 determines whether a section of the estimated route from the current vehicle position to the destination overlaps with another estimated route (step S12) for the purpose of selecting the destination candidates (narrowing down the scope of destination candidates), if the travel distance of the vehicle on the estimated route has reached the first distance since the current vehicle position has existed on the route (S8:YES). That is, the control unit 2 determines, as shown in FIG. 3A, whether the section of the route from the current vehicle position to the destination overlaps with another route after the travel distance of the vehicle on the estimated route has reached the first distance (a distance L1), in a situation that the current vehicle position is determined, for the first time after the start of the travel, to be existing on the overlapping portion of the two estimated routes P and Q. In this manner, the scope of the destination candidates is narrowed down.

To the contrary, if the determination of the current vehicle position on the route is for the second time or further, that is, if the determination is not for the first time, in addition to the determination that the vehicle has started the travel, with once being determined to be existing on the route and then having returned to the route again after straying away from the route (S7:NO), the process determines whether the travel route on the route reaches the second distance that is longer than the first distance (step S10), and further determines whether the current vehicle position is still existing on the route (step S11).

Then, the control unit 2 determines whether the section of the subsequent estimated route (the estimated route from the current vehicle position to the destination) overlaps with other estimated routes (step S12), if travel distance on the route after the “on-route” determination is determined to have reached the second distance since being continuously determined to be existing on the route without stray-away from the route (S10:YES). That is, as shown in FIG. 3B, after determining whether the current vehicle position is on the estimated route at least for a distance L2 that is greater than L1, after on-the-route travel (on routes P & Q), “stray-away” and returning to the estimated routes P & Q again, whether one of the estimated routes (e.g., the estimated route P) is still overlapping with another route (e.g., the estimated route Q) is determined by the control unit 2.

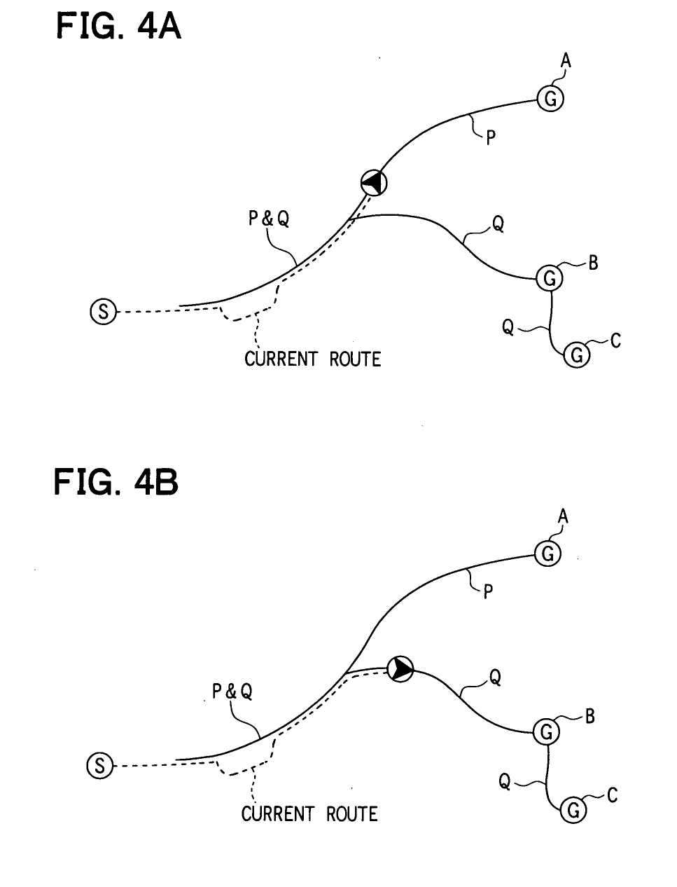

Then, if the narrowing-down of the scope of destination selection is successful, that is, if the control unit 2 determines that the subsequent estimated route (a route section from the current vehicle position to the destination) is not overlapping with another route (S12:YES), the number of the remaining destination candidates is examined. That is, whether the number of the remaining destination candidates is equal to one or not is determined (step S13). If the number is determined as equal to one (S13:YES), then the control unit 2 performs a process that targets the subsequent estimated route (step S14:designated as “only one destination process” in FIG. 2). That is, in a situation illustrated in FIG. 4A, the control unit 2 performs a process that targets the subsequent estimated route to only one destination candidate A, as a result of determination that, due to the fact that the remaining portion of the estimated route is not overlapping, with other routes, the current vehicle position is concluded as being on the estimated route P at a position past a branch that divides the route P and the route Q, with the only one remaining destination candidate A.

In this case, if control unit 2 detects a traffic congestion on the route to the selected destination A based on information from a traffic information service received by a VICS receiver 7 (such. as VICS information from VICS service implemented in Japan), the congested section of the route is displayed on the display unit 8 as a notification for an occupant of the vehicle. Further, as the only one destination has been selected, a detour route to the selected destination A for avoiding the congestion is also displayed on the display. unit 8 for the occupant. That is, in other words, by displaying the detour route, the added value for the occupant is provided as the detour route display for the destination selected situation in comparison to the destination not-yet-selected situation.

If, on the other hand, the control unit 2 determines that the number of the destination candidates is not one, that is, if the number of the remaining destination candidates is two or more (S13:NO), the control unit 2 performs a process that targets a nearest destination candidate to the current vehicle position from among the multiple destination candidates (step S15). That is, the control unit 2 performs, as shown in FIG. 4B, the control unit 2 performs a process that targets the subsequent estimated route to the nearest destination candidate B, as a result of determination that, due to the fact that the remaining portion of the estimated route is not overlapping with other routes, the current vehicle position is concluded as being on the estimated route Q, at a position past a branch that divides the route P and the route Q, with two or more remaining destination candidates to be selected, that is, in this case, the destination candidates B and C.

In this case, if the control unit 2 detects a traffic congestion on the route to the selected destination B based on information from the traffic information service received by the VICS. receiver 7 (such as VICS information from VICS service implemented in Japan), the congested section of the route is displayed on the display unit 8 as a notification for an occupant of the vehicle. However, due to the fact that the only one destination has not yet been determined, the detour route that avoids the congestion is not displayed on the display unit 8.

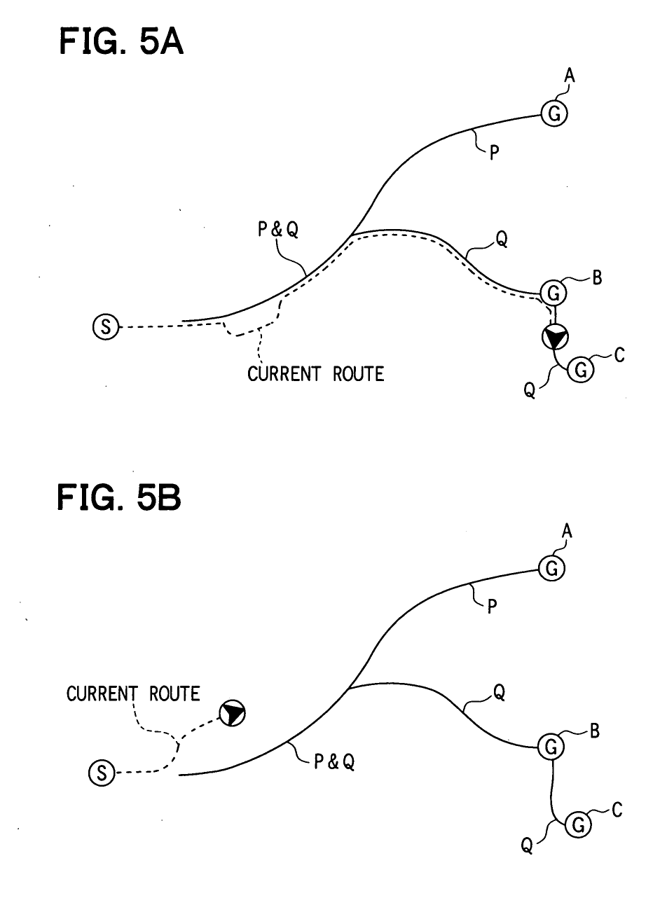

Furthermore, if the current vehicle position is at a position past the destination candidate B as shown in FIG. 5A, the situation indicates that the destination candidate C is selected as the only, one destination candidate, thereby leading to the performance of the process that targets the only one destination candidate by the control unit 2. That is, the same process as the process for the only destination candidate A is performed by the control unit 2 for the subsequent estimated route Q and the destination candidate C. In this case, if the control unit 2 detects a traffic congestion on the route to the selected destination C based on information from the traffic information service received by the VICS receiver 7 (such as VICS information from VICS service implemented in Japan), the congested section of the route is displayed on the display unit 8 as a notification for an occupant of the vehicle. Further, as the only one destination has been selected, a detour route to the selected destination C for avoiding the congestion is also displayed on the display unit 8 for the occupant.

The control unit 2 then determines, in step S16, whether or not the ACC switch is turned off by using the power control unit 13 (step S16). As long as the ACC switch is remaining to be turned on (S16:NO), the process returns to step S5 for repeating the subsequent process. Further, the control unit 2 watches the travel condition of the vehicle as shown in FIG. 5B, thereby returning the process to step S5 for repeating the subsequent process, whenever detecting that the current vehicle position is not existing on the estimated route (S6:NO). Further, when the control unit 2 determines that the current vehicle position is not continuously existing on the estimated route after once determining that the current vehicle position is on the route (S9:NO then S11:NO), the control unit 2 subsequently determines whether the subsequent estimated route portion (a section of the estimated route between the current vehicle position and the destination) overlaps with other routes (step S12). If the overlapping of the subsequent estimated route with other route is detected in this situation (S12:NO), the control unit 2 returns the process to step S5 for repeating the subsequent process.

As explained above, the vehicle navigation system 1 identifies an estimated route that corresponds to the destination candidate based on the travel history that accumulates the traveled routes in the past, determines whether the currently traveled route having the current vehicle position matches with the estimated route, and selects the destination candidate by determining whether the overlapping of the currently traveled route (which now is the estimated travel route due to the determination result if the determination itself is in the affirmative) with other estimated route. Therefore, the selection of the destination candidate can be performed in consideration of the previously traveled routes. That is, in other words, complicated processing such as estimating a travel purpose or the like can be omitted from a destination estimation process for accurately determining the user desired destination of the travel. That is, the usability of the vehicle navigation apparatus 1 is substantially improved in terms of simplicity and cost-effectiveness of the apparatus.

In addition, when the on-route determination (the current vehicle position is on the estimated route) is for the first time in a duration of time that starts at the latest turning-on of system power supply with the continuation of power-on afterwards, the selection of the destination candidates starts after the travel distance of the vehicle on the estimated route exceeds the first distance L1. Or, alternatively, when the on-route determination is for the second time or further in the above-described duration of time, the selection of the destination candidates starts after the travel distance of the vehicle exceeds the second distance L2 that is longer than the distance L1. That is, in other words, mistaking an inadvertent/unintentional travel of the vehicle on the estimated route as a travel according to the route guidance by the navigation apparatus 1 can thus be prevented. Further, a situation representative of the vehicle firstly reaching the estimated route can be distinguished from a situation that the vehicle has returned to the estimated route after once straying away from the route, thereby enabling an employment of different determination criterion for each of the situations in terms of determination of the possibility of continuation of the vehicle's travel to be continued on the estimated route. That is, in other words, mistaking an inadvertent/unintentional travel of the vehicle on the estimated route as the route-guided travel can be prevented to an improved degree of precision.

Although the present disclosure has been fully described in connection with preferred embodiment thereof with reference to the accompanying drawings, it is to be noted that various changes and modifications will become apparent to those skilled in the art.

For example, in accordance with the increase of the number of the “on-route determinations” in the duration after the latest -system tuning-on of system power supply, the threshold distance before starting the selection of destination candidates may be increased stepwise.

Further, the process that targets the section of the estimated route between the current vehicle position and the destination is not limited to the congestion notification processing, the congestion avoidance processing or the like. That is, various kinds of processing may be performed as the process that targets the remaining portion of the estimated route.

Such changes, modifications, and a summarized scheme are to be understood as being within the scope of the present disclosure as defined by appended claims.

1. A navigation apparatus having a current position detection unit, a road data acquisition unit, a map matching unit, a travel history store unit, the map matching unit matching a current vehicle position detected by the current position detection unit with the road data acquired by the road data acquisition unit, the travel history store unit storing traveled routes traveled by a vehicle as travel history of the vehicle, the apparatus comprising:
a destination history store unit for storing one of (a) the current vehicle position being detected by the current position detection unit at a time immediately before system power off and (b) a destination having been input by an occupant of the vehicle though an operation of an operation unit, as destination history;
a destination candidate estimation unit for estimating a destination candidate based on the destination history stored in the destination history store unit;
a route estimation unit for generating a route estimation that corresponds to the estimated destination candidate based on the travel history stored in the travel history store unit;
a route determination unit for determining whether the current vehicle position exists on the route estimation based on a comparison of the current vehicle position detected by the current position detection unit with the route estimation generated by the route estimation unit; and
a destination selection unit for selecting the destination candidate based on a determination whether a portion of one route estimation extending from the current vehicle position to the destination candidate is at least partially shared with another route estimation, when the current vehicle position is determined to be existing on the route estimation by the route determination unit.

2. The navigation apparatus of claim 1, wherein
when the current vehicle position is determined to be existing on the route estimation by the route determination unit, the destination selection unit starts a selection of the destination candidate by staring a determination whether a portion of one route estimation extending from the current vehicle position to the destination candidate is at least partially shared with another route estimation after detecting that a travel distance of the vehicle on the route estimation reaches a threshold.

3. The navigation apparatus of claim 2, wherein
when the current vehicle position is determined to be existing on the route estimation by the route determination unit, the destination selection unit starts a selection of the destination candidate either (a) by starting a determination whether a portion of one route estimation extending from the current vehicle position to the destination candidate is at least partially shared with another route estimation after detecting that a travel distance of the vehicle on the route estimation reaches a first threshold in case that the current vehicle position is determined to be existing on the route estimation by the route determination unit for a first time in a power-on continuation duration from a latest system power on, or (b) by starting a determination whether a portion of one route estimation extending from the current vehicle position to the destination candidate is at least partially shared with another route estimation after detecting that a travel distance of the vehicle on the route estimation reaches a second threshold that is greater than the first threshold in case that the current vehicle position is determined to be existing on the route estimation by the route determination unit for a second time or more in a power-on continuation duration from the latest system power on.

4. The navigation apparatus of claim 1 further comprising:
a process unit for performing a process that targets a section from the current vehicle position to one of the destination candidates when the destination selection unit has selected only one destination candidate.

5. The navigation apparatus of claim 1 further comprising:
a process unit for performing a process that targets a section from the current vehicle position to one of multiple destination candidates nearest to the current vehicle position when the destination selection unit has selected the multiple destination candidates.
